(19) United States
(12) Patent Application Publication
(10) Pub. No.: US 2015/0165953 A1
(43) Pub. Date: Jun. 18, 2015

(54) AUTOMOBILE CUP HOLDER

(71) Applicant: Hyundai Motor Company, Seoul (KR)

(72) Inventors: Man Ju Oh, Yongin-si (KR); Jae Woong KIM, Hwaseong-si (KR); Jae Woo PARK, Ansan-si (KR)

(73) Assignee: Hyundai Motor Company, Seoul (KR)

(21) Appl. No.: 14/293,944

(22) Filed: Jun. 2, 2014

(30) Foreign Application Priority Data
Dec. 18, 2013 (KR) 10-2013-0157917

(51) Int. Cl. B60N 3/10

(52) U.S. Cl. CPC B60N 3/104

(57) ABSTRACT

An automobile cup holder may include a holding unit which accommodates a cup and exchanges heat with the cup, a thermoelectric element which is in contact with an outer surface of the holding unit to cool or heat the holding unit, and a bimetal which is arranged adjacent to the holding unit and connected to respective ends of a circuit of the thermoelectric element.

### CROSS REFERENCE TO RELATED APPLICATION

The present application claims priority of Korean Patent Application Number 10-2013-0157917 filed on Dec. 18, 2013, the entire contents of which application are incorporated herein for all purposes by this reference.

### BACKGROUND OF INVENTION

1. Field of Invention

The present invention relates to an automobile cup holder, and more particularly to an automobile cup holder which is configured to prevent overheating and thus protect a driver or passenger's hand from an excessively high temperature of the cup holder.

2. Description of Related Art

There are automobile cup holders having the functions of heating and cooling. When the cup holder operates for heating, the surface of a cup accommodated in the cup holder is heated and becomes very hot. When the temperature of the cup holder cannot be controlled, the cup holder will overheat, causing the problem that a user's hand easily gets burned and the contents in the cup expand due to increased temperature and may erupt from the cup.

Conventional measures to solve the problems include attaching a temperature sensor to the cup holder and mounting a logic circuit which controls the temperature of the cup holder. However, this solution involves not only cost problems such as an increase in labor in manufacturing processes and an increase in raw materials cost but also durability and reliability problems such as the risk of a malfunctioning temperature sensor.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the related art and/or other problems, and the present invention is intended to provide an automobile cup holder equipped with a bimetal which mechanically controls cooling or heating of a cup holder instead of using a complex temperature sensor, and which simplifies the structure of the cup holder. For this reason, there is no risk of malfunctioning of the temperature sensor, resulting in an improvement in operation reliability of the automobile cup holder. Furthermore, the simplified structure of the automobile cup holder reduces labor in the manufacturing process.

According to various aspects of the present invention, there is provided an automobile cup holder including a holding unit which accommodates a cup and exchanges heat with the cup, a thermoelectric element which is in contact with an outer surface of the holding unit to cool or heat the holding unit, and a bimetal which is arranged adjacent to the holding unit and connected to respective ends of a circuit of the thermoelectric element.

A second panel of the thermoelectric element may be provided with a heat-dissipating fin and the bimetal may be attached to the heat-dissipating fin. A portion of a first or second panel of the thermoelectric element may extend outside the thermoelectric element, and the bimetal may be attached to the extended portion of the first or second panel of the thermoelectric element.

The bimetal may be attached to an outer surface of the holding unit.

A portion of a first panel or the second panel of the thermoelectric element may extend outside the thermoelectric element, the extended portion of the first or second panel may be bent to be located in a space between the holding unit and the heat-dissipating fin, and the bimetal may be attached to the extended portion of the first or second panel of the thermoelectric element.

The bimetal may operate to supply or interrupt power to the thermoelectric element when a temperature of the holding unit is outside a desired temperature range which is preset.

An automobile cup holder according to the present invention reliably operates because it does not use a logic circuit to control temperature but uses a mechanical mechanism. Moreover, since the automobile cup holder is integrated with a thermoelectric element, it can be manufactured at low cost and with reduced labor. Furthermore, since the automobile cup holder has a simple structure, it can find its application in a variety of vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a first exemplary automobile cup holder according to the present invention;

FIGS. 2A and 2B are perspective views illustrating connection between a bimetal and a thermoelectric element of the first exemplary automobile cup holder according to the present invention;

FIG. 3 is a perspective view illustrating a second exemplary automobile cup holder according to the present invention;

FIG. 4 illustrates illustrating a third exemplary automobile cup holder according to the present invention; and

FIG. 5 illustrates illustrating a fourth exemplary automobile cup holder according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

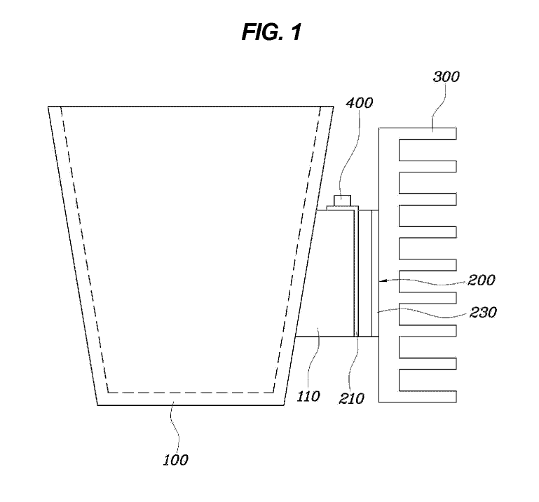

FIG. 1 illustrates an automobile cup holder according to a first embodiment of the present invention. With reference to FIG. 1, the automobile cup holder according to the first embodiment includes a holding unit 100, a thermoelectric element 200, and a bimetal 400. The holding unit 100 accommodates a cup therein and transmits heat to the cup. The thermoelectric element 200 is in contact with the outer surface of the holding unit 100 and cools or heats the holding unit 100. The bimetal 400 is arranged near or adjacent to the holding unit 100 and connected to respective ends of a circuit of the thermoelectric element 200.

Specifically, the automobile cup holder has a cup shape so as to accommodate a cup therein and is made of a metallic material which is a heat conductive material. Most of the outer surface of the cup holder except an area with which the thermoelectric element 200 is in contact is covered by a covering. This prevents a driver's or passenger's hand from being burned when the driver or passenger holds or touches the holding unit 100.

The thermoelectric element 200 is a Peltier element which has a first panel 210 and a second panel 230 and operates such that the first panel 210 becomes cold and the second panel 230 becomes hot or vice versa, depending on the direction of current applied to the thermoelectric element 200. In this manner, the Peltier element cools or heats an object which is in contact with the first panel 210 or the second panel 230. For illustration purposes, first through fourth embodiments of the present invention described below are all based on the structure in which the first panel 210 of the thermoelectric element 200 becomes hot and the second panel 230 becomes cold when the current flows to the thermoelectric element 200.

The second panel 230 of the thermoelectric element 200 may be provided with a heat-dissipating fin 300 to dissipate heat.

The bimetal 400 transmits or intercepts electric current, according to a preset temperature. In various embodiments, the bimetal 400 is preferably connected to respective ends of the thermoelectric element 200. That is, the bimetal is disposed in the middle of a current flow path to the thermoelectric element 200. Accordingly, whether a current is applied to the thermoelectric element 200 or not depends on the action or operation of the bimetal 400.

The use of the bimetal 400 enables the temperature of the cup holder to be controlled within a predetermined temperature range and makes a logic circuit for controlling the cup holder unnecessary, resulting in the simplified structure of the automobile cup holder. Furthermore, since it is unnecessary to use an additional temperature sensor, there is no risk of malfunctioning of the additional sensor or logic circuit, resulting in an improvement in operation reliability.

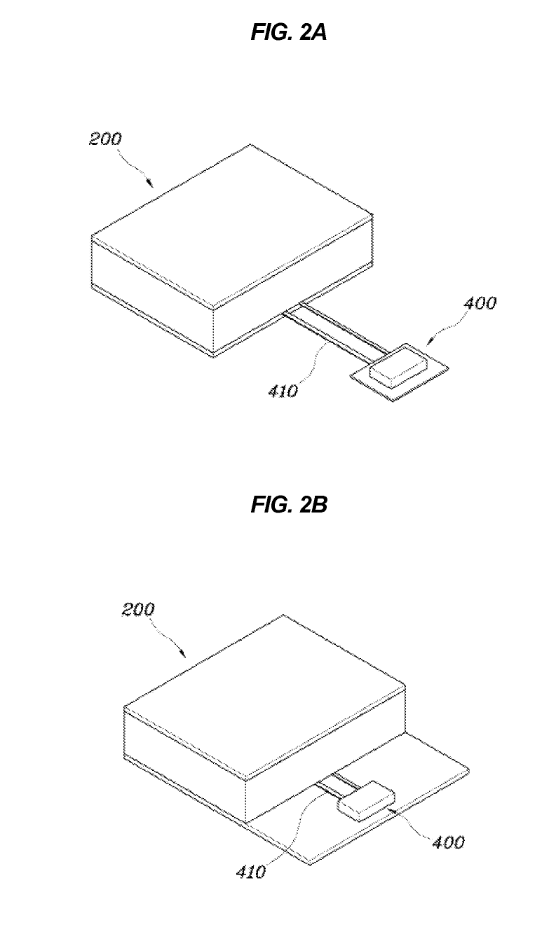

The bimetal 400 and the thermoelectric element 200 are separate parts. As illustrated in FIG. 2A, the bimetal 400 and the thermoelectric element 200 may be physically separated from each other but electrically connected to each other via wire. Alternatively, as illustrated in FIG. 2B, the bimetal 400 may be disposed on an extension of the first panel 210 or the second panel 230 of the thermoelectric element 200. Further alternatively, the bimetal 400 may be disposed at any place regardless of the position of the thermoelectric element.

For example, the bimetal 400 may be arranged in the position illustrated in FIG. 1. To this end, the outer surface of the holding unit 100 is provided with a contact protrusion 110 to which the thermoelectric element 200 is to be attached. In this case, the bimetal 400 can make a stable contact with the thermoelectric element 200 regardless of the shape of the cup holder. Alternatively, the first panel 210 of the thermoelectric element 200 is configured to extend outside the thermoelectric element 200 while maintaining contact with the contact protrusion 110 and the bimetal 400 is attached to the extended portion of the first panel 210 of the thermoelectric element 200. To attach the bimetal 400, an adhesive or an additional support means may be used. Other attaching methods also may be used.

Since the bimetal 400 is in direct contact with the first panel 210 of the thermoelectric element 200, when the temperature of the thermoelectric element 200 exceeds the preset operation temperature of the bimetal 400, power is interrupted so that current is not supplied to the thermoelectric element 200 any longer. In this way, immediate and prompt temperature control is possible.

The operation temperature of the bimetal 400 varies depending on the position in which the bimetal 400 is installed. To determine the operation temperature of the bimetal 400, a desired temperature range which is a temperature range of the holding unit 100 is set, and a temperature range of the thermoelectric element 200, for example, 40 to 60° C. which corresponds to the desired temperature range of the holding unit 100 is obtained through experiments. The bimetal 400 allows the flow of current to the thermoelectric element 200 at below the temperature of the thermoelectric element 200 which corresponds to the lower limit of the desired temperature range of the holding unit 100 but intercepts the current flowing to the thermoelectric element 200 at temperatures above the temperature of the thermoelectric element 200 which corresponds to the upper limit of the desired temperature range of the holding unit 100. That is, when the temperature of the holding unit 100 rises and reaches the upper limit of the desired temperature range of the holding unit 100, the bimetal 400 blocks the flow of current to the thermoelectric element 200 so that the holding unit 100 can be cooled down. Conversely, when the temperature of the holding unit 100 falls to below the lower limit of the desired temperature of the holding unit 100, the bimetal 400 operates to enable current to flow to the thermoelectric element 200 and the conductive state is maintained until the temperature of the holding unit 100 rises and reaches the upper limit of the desired temperature.

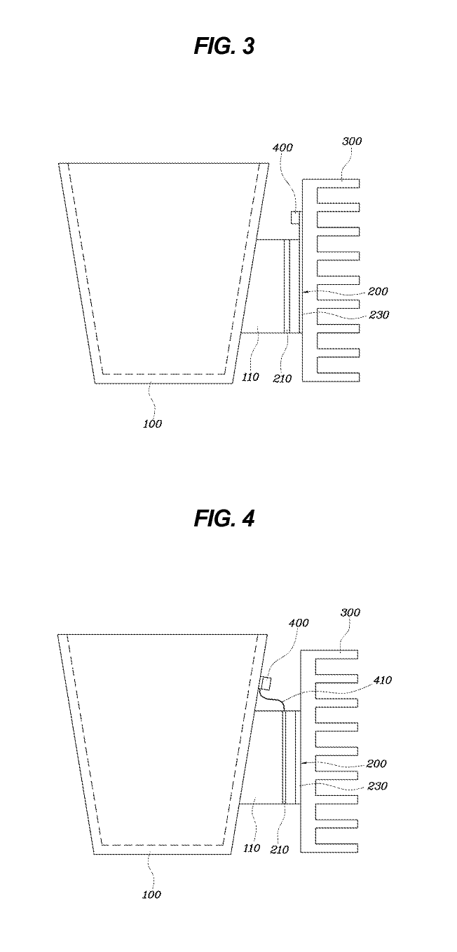

The embodiments of the present invention are different in the position in which the bimetal 400 is installed. FIG. 3 illustrates an automobile cup holder according to a second embodiment of the present invention. According to the second embodiment, the bimetal 400 is attached to the heat-dissipating fin 300. The bimetal 400 is attached to the heat-dissipating fin 300 while being separated from the thermoelectric element 200. Alternatively, as illustrated in FIG. 3, the second panel 230 of the thermoelectric element 200 has an extension which extends outside the thermoelectric element 200 from the second panel 230, and the bimetal 400 is located on the extension of the second panel 230. In this case, the bimetal 400 operates according to the temperature of the second panel 230.

In the thermoelectric element 200, the first panel 210 and the second panel 230 need to maintain a predetermined temperature difference therebetween. Accordingly, temperatures of the second panel 230 or the heat-dissipating fin 300 which correspond to the desired temperature range of the holding unit 100 should be obtained through experiments, and the operation of the bimetal 400 is controlled by the temperature of the second panel 230 of the thermoelectric element 200 or the heat-dissipating fin 300.

FIG. 4 illustrates installation of an automobile cup holder according to a third embodiment of the present invention. With reference to FIG. 4, the bimetal 400 is attached to the outer surface of the holding unit 100. In this case, the bimetal 400 may be attached to a portion of the outer surface other than a portion in which the contact protrusion 110 is installed, and the bimetal 400 may operate according to the temperature of the holding unit 100. A method of setting an operation temperature of the bimetal 400 may be the same as in the first and second embodiments.

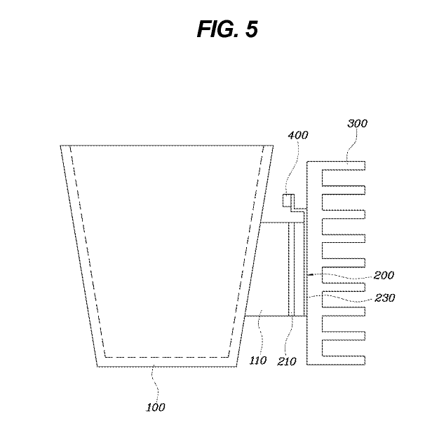

FIG. 5 illustrates installation of an automobile cup holder according to a fourth embodiment of the present invention. According to the fourth embodiment, the bimetal 400 is installed in a space between the holding unit 100 and the heat-dissipating fin 300.

In this case, a portion of the second panel 230 extends outside the thermoelectric element 200, and the extended portion is bent to be located in a space between the holding unit 100 and the heat-dissipating fin 300. In various embodiments, the bimetal 400 is preferably attached to the extended portion of the second panel 230 of the thermoelectric element 200. Even in this case, preferably the bimetal 400 may operate according to the temperature of the portion of the holding unit 100 at which the bimetal 400 is located. That is, when the temperature of the holding unit 100 exceeds the desired temperature range, power supply to the thermoelectric element 200 is interrupted.

Alternatively, a portion of the first panel 210 of the thermoelectric element 200 may extend outside the thermoelectric element 200 and the bimetal 400 may be installed in the extended portion of the first panel 210.

The second to fourth embodiments are different in the position in which the bimetal 400 is installed but are the same in the method of setting the operation temperature and the components of the bimetal 400.

The automobile cup holders according to the above-described embodiments have at least the following advantages. First, the automobile cup holder does not require an additional logic circuit to control the temperature thereof and operates with a mechanical mechanism. Accordingly, the automobile cup holder according to any of the embodiments of the present invention has improved reliability in its operation. Second, since the automobile cup holder is integrated with the thermoelectric element, it can be manufactured at lower cost and with less labor compared to conventional automobile cup holders. Third, it can be used in various types of vehicles.

For convenience in explanation and accurate definition in the appended claims, the terms “upper” or “lower”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An automobile cup holder comprising:
a holding unit which accommodates a cup and exchanges heat with the cup;
a thermoelectric element which is in contact with an outer surface of the holding unit to cool or heat the holding unit; and
a bimetal which is arranged adjacent to the holding unit and connected to respective ends of a circuit of the thermoelectric element.

2. The automobile cup holder according to claim 1, wherein a second panel of the thermoelectric element is provided with a heat-dissipating fin and the bimetal is attached to the heat-dissipating fin.

3. The automobile cup holder according to claim 1, wherein a portion of a first panel or a second panel of the thermoelectric element extends outside the thermoelectric element, and the bimetal is attached to the extended portion of the first panel or the second panel.

4. The automobile cup holder according to claim 1, wherein the bimetal is attached to an outer surface of the holding unit.

5. The automobile cup holder according to claim 2, wherein a portion of a first panel or the second panel of the thermoelectric element extends outside the thermoelectric element, the extended portion of the first or second panel is bent to be located in a space between the holding unit and the heat-dissipating fin, and the bimetal is attached to the extended portion of the first or second panel of the thermoelectric element.

6. The automobile cup holder according to claim 1, wherein the bimetal operates to supply or interrupt power to the thermoelectric element when a temperature of the holding unit is outside a desired temperature range which is preset.
